(19) United States
(12) Patent Application Publication
(10) Pub. No.: US 2014/0023915 A1
(43) Pub. Date: Jan. 23, 2014

(54) NON-AQUEOUS ELECTROLYTE SECONDARY CELL

(71) Applicants: Tetsuya Matsuda, Kasai-shi (JP); Keisuke Minami, Kanzaki-gun (JP); Toyoki Fujihara, Kanzaki-gun (JP); Toshiyuki Nohma, Kobe-shi (JP)

(72) Inventors: Tetsuya Matsuda, Kasai-shi (JP); Keisuke Minami, Kanzaki-gun (JP); Toyoki Fujihara, Kanzaki-gun (JP); Toshiyuki Nohma, Kobe-shi (JP)

(73) Assignee: SANYO ELECTRIC CO., LTD., Osaka (JP)

(21) Appl. No.: 13/550,750

(22) Filed: Jul. 17, 2012

(51) Int. Cl. H01M 10/056

(52) U.S. Cl. 429/199; 429/188

(57) ABSTRACT

The present invention aims to productively provide a non-aqueous electrolyte secondary cell having high capacity. This object can be achieved by adopting the following configuration. A non-aqueous electrolyte secondary cell comprises a non-aqueous electrolyte and an electrode assembly having a positive electrode, a negative electrode and a separator; the positive electrode has a positive electrode core and a positive electrode active material layer; the negative electrode has a negative electrode core and a negative electrode active material layer; a protective layer is provided on the positive electrode active material layer and/or the negative electrode active material layer; the total thickness of the protective layers is 10 to 40% of that of the separator; a porosity of the protective layer is larger than that of any of the positive and negative electrode active material layer; and the non-aqueous electrolyte contains a non-aqueous solvent and two or more kinds of lithium compounds.

### BACKGROUND OF THE INVENTION

1. Field of the Invention

The present invention relates to a non-aqueous electrolyte secondary cell.

2. Background Art

Recently, there have become popular battery-powered vehicles such as electric vehicles (EV) and hybrid electric vehicles (HEV), which use a secondary cell as a drive power source. The cell-powered vehicles require a secondary cell with high output and high capacity.

A non-aqueous electrolyte secondary cell typified by a lithium ion secondary cell has high energy density and high capacity. Moreover, because of its large facing area between the positive and negative electrode plates, it is easy to draw a large current from the electrode assembly formed by winding or laminating the positive and negative electrode plates comprising active material layers provided on both surfaces of the electrode core via a separator. For this reason, the non-aqueous electrolyte secondary cell having the laminated or spirally wound electrode assembly is used in the above applications.

In such applications, it is required to enhance output characteristics or temperature characteristics and to secure safety for the purpose of stable takeout of large electric current. For this purpose, various additives are often added to the non-aqueous electrolyte. However, since the addition of additives to the non-aqueous electrolyte increases the viscosity of the non-aqueous electrolyte, the non-aqueous electrolyte becomes difficult to penetrate into the electrode, thus causing problems such as degradation in the productivity.

### SUMMARY OF THE INVENTION

The present invention is made in view of the above, and aims to productively provide a non-aqueous electrolyte secondary cell having high capacity.

The present invention of the prismatic cell for the purpose of solution of the above problems has the following configuration.

A non-aqueous electrolyte secondary cell comprising an electrode assembly and a non-aqueous electrolyte,

wherein:

the electrode assembly has a positive electrode plate, a negative electrode plate, and a separator separating the positive and negative electrode plates;

the positive electrode plate has a positive electrode core and a positive electrode active material layer formed on the positive electrode core; the negative electrode plate has a negative electrode core and a negative electrode active material layer formed on the negative electrode core;

a protective layer containing insulative inorganic particles is provided on the positive electrode active material layer and/or the negative electrode active material layer;

the total thickness of the protective layers is 10 to 40% of the thickness of the separator;

the porosity of the protective layer is larger than the porisity of any of the positive electrode active material layer and the negative electrode active material layer; and

the non-aqueous electrolyte contains a non-aqueous solvent and two or more kinds of lithium compounds dissolved in the non-aqueous solvent.

In the above configuration, two or more kinds of lithium compounds are dissolved in the non-aqueous electrolyte, thereby enhancing the cell's durability, output characteristics, safety, etc. Moreover, the protective layer with a larger porosity than any of the positive and negative electrode active material layers is provided on at least one of the positive and negative active material layers, thereby enhancing the liquid permeability of the electrode plate having the protective layer. For this reason, the productivity is improved because it is possible to smoothly penetrate the non-aqueous electrolyte, which has an increased viscosity due to dissolution of two or more kinds of lithium compounds, into the inside of the electrode plate. In addition to this, there is prevented the occurrence of shortage of the non-aqueous electrolyte during charge and discharge, thus improving charge/discharge characteristics such as cycle characteristics and low-temperature characteristics.

When the total thickness of the protective layers is less than 10% of the thickness of the separator, non-aqueous electrolyte retention function or penetration enhancing function is not obtained sufficiently. On the other hand, when the total thickness of the protective layers is greater than 40% of the thickness of the separator, volumetric energy density is reduced due to the increased thickness of the protective layer that does not directly contribute to the charge and discharge.

In the case that the protective layer is provided on either only one of the positive and negative electrode active material layers, the total thickness of the protective layer indicates the thickness of the provided protective layer. When the active material layer is formed on both surfaces of the core and when the protective layer is formed on each of the active material layers, each thickness of the protective layers is set to 10 to 40% of the thickness of the separator.

Meanwhile, in the case that the protective layer is respectively provided on both of the positive and negative electrode active material layers, the total thickness of the protective layer indicates the sum of the thicknesses of the protective layers. When the active material layers are formed on both surfaces of the cores of the positive and negative electrodes and when the protective layer is formed on each of the active material layers, the respective total thicknesses of the protective layers of the positive and negative electrodes opposed via the separator are set to 10 to 40% of the thickness of the separator.

In the above configuration, the non-aqueous electrolyte may contain three or more kinds of lithium compounds dissolved in the non-aqueous solvent.

At least three kinds of lithium compounds allow further improving the safety.

It is also preferable that lithium bis(oxalate)borate is used as the lithium compound because the cycle characteristics of the non-aqueous electrolyte secondary cell is improved.

In addition, it is preferable that lithium difluorophosphate is used as the lithium compound because of increasing the low-temperature output characteristics. More preferably, both lithium bis(oxalate)borate and lithium difluorophosphate are used.

Lithium bis(oxalate)borate and lithium difluorophosphate tend to increase the viscosity. Therefore, in addition to these compounds, it is preferable to contain a lithium compound (a fundamental electrolyte salt) in order to improve the quality of the non-aqueous electrolyte. The fundamental electrolyte salt preferably includes LiPF₆, LiN(C₂F₅SO₂)₂, LiN(CF₃SO₂)₂, LiClO₄ and LiBF₄. The total concentration of the lithium compounds is preferably 0.5 to 2.0 M(mol/l).

In addition, it is preferable the present invention is applied to a cell using an electrode assembly formed by winding positive and negative electrode plates via a separator.

Moreover, it is preferable that the present invention is applied to a high capacity cell having cell capacity of 4 Ah or more.

The permeability of the electrolyte is low in the above non-aqueous electrolyte secondary cell using a spirally wound electrode assembly or the above non-aqueous electrolyte secondary cell having high capacity. Therefore, when the present invention is applied to such cells, the above-mentioned effects are enhanced.

Herein, the cell capacity means discharge capacity (initial capacity) measured in the third step of the following steps:

The cell is charged at a constant current of 1 It to a voltage of 4.1V, then charged at a constant voltage of 4.1V for 2.5 hours, and then discharged at a constant current of 1 It to a voltage of 2.5 V.

The charging and discharging are all performed at 25° C. In addition, the value of 1 It is an electric current value that allows the cell capacity to be discharged in one hour.

In addition, when the active material layer is formed on both surfaces of the core and when the protective layer is formed on each of the active material layers, it is preferable that each thickness of the protective layers is identical in both surfaces. When the protective layer is a provided on each of the positive and negative electrodes, it is also preferable that each thickness of the protective layers is identical.

### BRIEF DESCRIPTION OF THE DRAWING

FIG. 1 is a perspective view of a non-aqueous electrolyte secondary cell according to the present invention.

FIG. 2 is a diagram showing an electrode assembly used in the non-aqueous electrolyte secondary cell according to the present invention.

FIG. 3 is a plan view showing electrode plates used in the non-aqueous electrolyte secondary cell according to the present invention. FIG. 3A shows a positive electrode, and FIG. 3B shows a negative electrode.

### DESCRIPTION OF THE INVENTION

### Embodiment 1

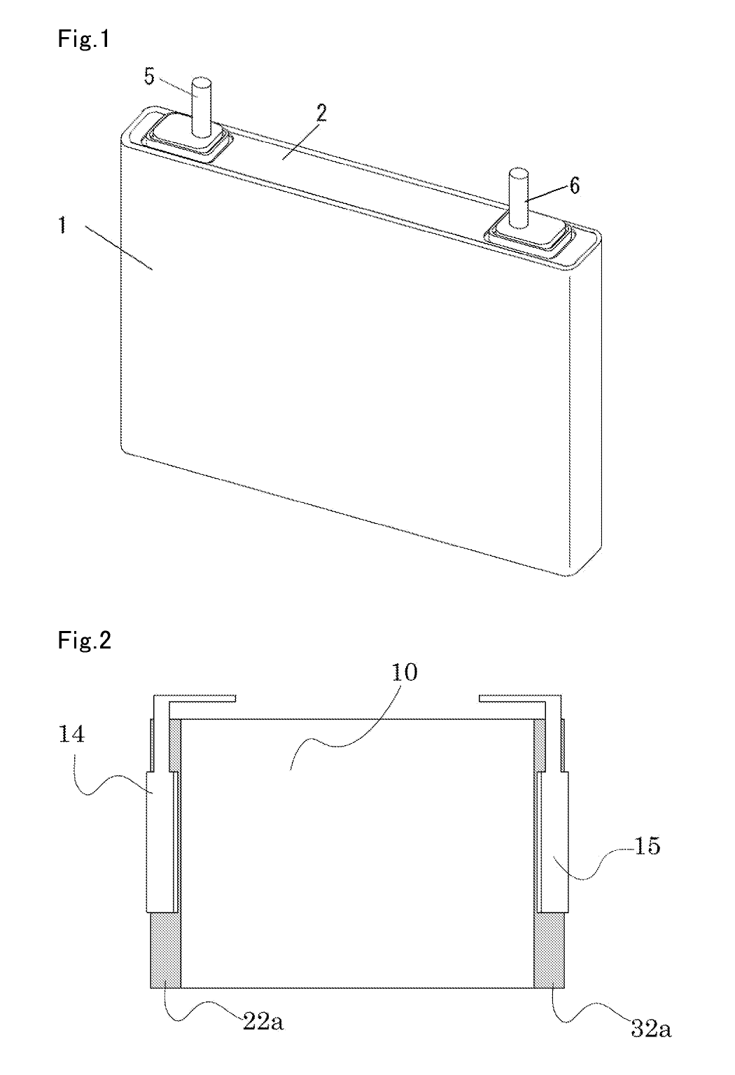

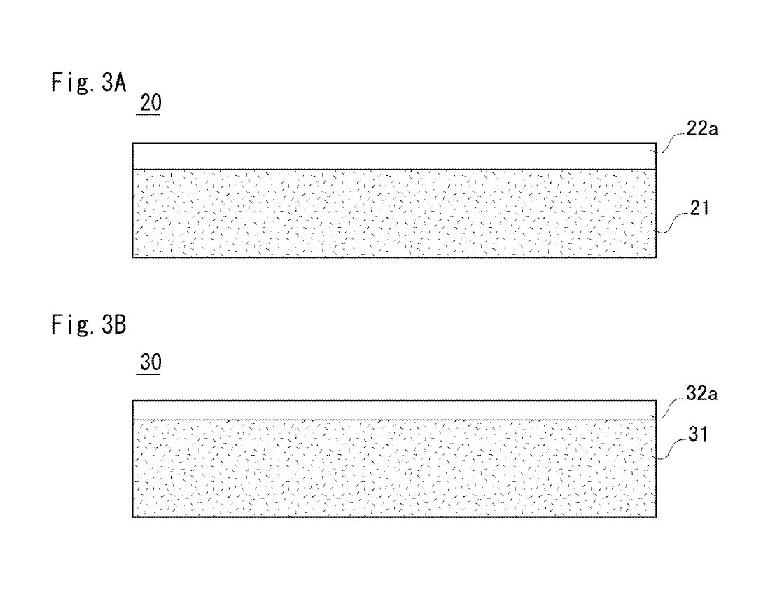

The present invention will be described below with reference to the drawings. FIG. 1 is a perspective view showing a non-aqueous electrolyte secondary cell according to the present invention. FIG. 2 is a diagram showing an electrode assembly used in non-aqueous electrolyte secondary cell according to the present invention. And FIG. 3 is a plan view showing electrode plates used in the non-aqueous electrolyte secondary cell according to the present invention. FIG. 3A shows a positive electrode, and FIG. 3B shows a negative electrode.

As shown in FIG. 1, the non-aqueous electrolyte secondary cell according to this Embodiment comprises a prismatic outer can 1 having an opening, a sealing body 2 for sealing the opening of the outer can 1, and positive and negative electrode external terminals 5 and 6 protruding outwardly from the sealing body 2.

As shown in FIG. 3A, the positive electrode plate constituting the electrode assembly comprises: a positive electrode core exposed portion 22a in which at least one end is exposed along the longitudinal direction of the belt-shaped positive electrode core; and a positive electrode active material layer 21 formed on positive electrode core. Meanwhile, as shown in FIG. 3B, the negative electrode plate comprises: a negative electrode core exposed portion 32a in which at least one end is exposed along the longitudinal direction of the belt-shaped negative electrode core; and a negative electrode active material layer 31 formed on the negative electrode core. The electrode assembly 10 is formed by winding the positive electrode 20 and negative electrode 30 via a separator (not shown) consisting of a microporous membrane made of polyethylene. As shown in FIG. 2, the positive electrode core exposed portion, on which the active material layer of the positive electrode 20 is not formed, projects from one end of the electrode assembly 10 while the negative electrode core exposed portion, on which the active material layer of the negative electrode 30 is not formed, projects from the other end of the electrode assembly 10. The positive electrode current collector plate 14 is attached to the positive electrode core exposed portion while the negative electrode current collector plate 15 is attached to the negative electrode core exposed portion.

This electrode assembly 10 is accommodated in the above outer can 1 with the non-aqueous electrolyte. The positive electrode current collector plate 14 and negative electrode current collector plate 15 are electrically connected to external terminals 5 and 6 projecting and insulated from the sealing body 2, respectively. Thereby, electrical current is extracted to the outside.

On the negative electrode active material layer, there is provided a protective layer comprising insulative inorganic particles and a binder. It is preferable that the thickness of the protective layer is 1 to 10 μm, and the porosity of the protective layer is 60 to 90% and more than the porosity of the negative electrode active material layer. And it is also preferable that the average particle diameter of the insulative inorganic particles is 0.1 to 10 μm. In addition, the insulative inorganic particles are preferably at least one kind of particles selected from the group consisting of alumina particles, titania particles and zirconia particles. Also, a protective layer may be formed on the negative electrode core exposed portion that is continuous to the negative electrode active material layer.

The protective layer may be also provided on the positive electrode active material layer. Also in this case, it is preferable that the thickness of the protective layer is 1 to 10 μm, and that the porosity of the protective layer is 60 to 90% and more than the porosity of the positive electrode active material layer. In addition, the protective layer may be also provided on the positive electrode core exposed portion continuous to the positive electrode active material layer.

Moreover, the protective layer may be also provided on the positive and negative electrode active material layers. In this case, it is preferable that the total thickness of the protective layers is 1 to 10 μm, and that the porosity of each protective layer is 60 to 90% and more than the porosities of the positive and negative electrode active material layers.

Hereinafter, the present invention is specifically explained using Examples. The present invention is not intended to be limited to the Examples, and the conditions such as used materials and mixing ratios can be varied accordingly.

### Example 1

### <Preparation of Positive Electrode>

A positive electrode active material of lithium nickel cobalt manganese oxide (LiNi_{0.35}Cu_{0.35}Mn_{0.3}O₂), a carbonaceous conductive agent such as acetylene black and graphite, and a binder of polyvinylidene fluoride (PVDF) were weighed at a mass ratio of 88:9:3. Then, these were dissolved in an organic solvent such as N-methyl-2-pyrrolidone (NMP) and mixed to prepare a positive electrode active material slurry.

Then, using a die coater or doctor blade, etc., the positive electrode active material slurry was applied in a uniform thickness on both surfaces of the positive electrode core composed of a belt-shaped aluminum foil (thickness 15 μm). However, the slurry was not applied on one side edge (the same side in both surfaces) of the positive electrode core along the longitudinal direction, thereby forming a positive electrode core exposed portion.

This electrode plate was passed through a dryer to remove the organic solvent and to prepare a dry electrode plate. This dry electrode plate was pressed using a roll press machine to prepare a positive electrode plate. Then, the resulting plate was cut into a predetermined size to prepare a positive electrode.

### <Preparation of Negative Electrode>

A negative electrode active material of graphite, a binder of a styrene-butadiene rubber, and a thickening agent of carboxymethylcellulose were weighed in a mass ratio of 98:1:1. Then, these were mixed with an appropriate amount of water to prepare a negative electrode active material slurry.

Then, using a die coater or doctor blade, etc., the negative electrode active material slurry was applied in a uniform thickness on both surfaces of the negative electrode core composed of a belt-shaped copper foil (thickness 10 μm). However, the slurry was not applied on one side edge (the same side in both surfaces) of the negative electrode core along the longitudinal direction, thereby forming a negative electrode core exposed portion.

This electrode plate was passed through a dryer to remove water to produce a dry electrode plate. Then, this dry electrode plate was rolled by a roll press machine.

Alumina powder as insulative inorganic particles, an acrylonitrile-based binder and NMP were mixed in a mass ratio of 30:0.9:69.1 to prepare a slurry, and this slurry was applied on the negative electrode active material layer on the dried and rolled electrode plate. This electrode plate was dried again, and NMP required for the slurry preparation was evaporated and removed, and was cut into a predetermined size to prepare the negative electrode forming the negative electrode protective layer with the thickness of 2 μm.

### <Preparation of Electrode Assembly>

Three members (a positive electrode, a negative electrode and a separator made of polyethylene with the thickness of 30 μm) were positioned and overlapped so that:

a plurality of the core expose portions of the same electrode might be directly overlapped;

the core exposed portions of different electrode might protrude in directions counter to each other relative to the winding direction; and

the separator might be interposed between the different active material layers.

The three laminated members are wound using a winder, and an insulative winding-end tape is stuck thereon. Then, the resulting wound body is pressed to complete a flat electrode assembly.

### <Connection of Current Collector Plate to Sealing Body>

There were prepared one positive electrode current collector plate 14 made of aluminum and one negative electrode current collector plate 15 made of copper, on each of which two convex portions (not shown) protruding to one plane side are formed. Moreover, there were prepared two positive electrode current collector plate receiving members (not shown) made of aluminum and two negative electrode current collector plate receiving members (not shown) made of copper, on each of which one convex portion protruding to one plane side is formed. Then, an insulating tape was stuck so as to surround the convex portions of the positive electrode current collector plate 14, the negative electrode current collector plate 15, the positive electrode current collector plate receiving member and the negative electrode current collector plate receiving member.

A gasket (not shown) was arranged inside of a through hole (not shown) formed in the sealing body 2, and arranged on the outer surface of the cell surrounding the through hole formed on the sealing body 2. Meanwhile, an insulating member (not shown) was arranged on the inner surface of the cell surrounding the through hole. And the positive electrode current collector plate 14 was positioned on the insulating member provided on the cell inner surface of the sealing body 2 so as to overlap the through hole of the sealing body 2 with the through-hole (not shown) provided in the current collector plate. Then, an insertion portion of the positive electrode external terminal 5 having a flange area (not shown) and an insertion area (not shown) was passed through the through holes of the sealing body 2 and the current collector plate from the outside of the cell. With this structure kept, the diameter of the lower part (cell inner part) of the insertion portion was increased, and the positive electrode external terminal 5 was caulked to the sealing body 2 together with the positive electrode current collector plate 14.

The same manner was also applied to the negative electrode. The negative electrode external terminal 6 was caulked to the sealing body 2 along with the negative electrode current collector plate 15. This process makes each member integrated, and further the positive and negative electrode current collector plates 14 and 15 are conductively connected to the positive and negative electrode external terminals 5 and 6. And the positive and negative electrode external terminals 5 and 6 protrude from the sealing body 2 with them insulated from the sealing body 2.

### <Attachment of Current Collector Plates>

Onto one surface of the core exposed portion in the positive electrode 20 of the flat electrode assembly, the positive electrode current collector plate 14 was applied with its convex portions on the side of the positive electrode core exposed portion. Then, one of the positive electrode current collecting plate receiving members is applied onto the positive electrode core exposed portion in such a manner that the convex portion thereof would come into contact with the positive electrode core exposed portion and that one of the convex portions of the positive electrode current collecting plate 14 and the convex portion of the positive electrode current collecting plate receiving member would oppose to one another. Thereafter, a pair of welding electrodes were applied on the back of the convex portion of the positive electrode current collector plate 14 and the back of the convex portion of the positive electrode current collecting plate receiving member. Electric current is flowed to the welding electrodes for a resistance welding of the positive electrode current collector plate 14 and the positive electrode current collecting plate receiving member to the positive electrode core exposed portion.

Then, the other positive electrode current collecting plate receiving members is applied onto the positive electrode core exposed portion in such a manner that the convex portion thereof would come into contact with the positive electrode core exposed portion and that the other convex portions of the positive electrode current collecting plate 14 and the convex portion of the positive electrode current collecting plate receiving member would oppose to one another. Thereafter, a pair of welding electrodes are applied on the back of the convex portion of the positive electrode current collector plate 14 and the back of the convex portion of the positive electrode current collecting plate receiving member. Electric current was flowed to the welding electrodes for a second resistance welding. Through the above process, the positive electrode current collector plate 14 and positive electrode current collector plate receiving member were fixed to the positive electrode core exposed portion.

The same manner was also applied to the negative electrode 30. The negative electrode current collector plate 15 and the negative electrode current collector plate receiving member were resistance welded.

### <Preparation of a Non-Aqueous Electrolyte>

LiPF₆ as an electrolyte salt was dissolved at 1.0M (mol/l) into non-aqueous solvent in which ethylene carbonate (EC) and ethyl methyl carbonate (EMC) were mixed in the ratio of 3:7 (volume ratio converted at 1 atm (101325 Pa) and 25° C.), thus forming a base electrolyte solution. Then, 0.3% by mass of vinylene carbonate, 0.1M of lithium bis(oxalate)borate and 0.05 M of lithium difluorophosphate (LiPO₂F₂) were added to the above base electrolyte solution to form a non-aqueous electrolyte.

### <Assembly of Cells>

The electrode assembly 10 integrated with the sealing body 2 was inserted in an outer can 1, and the opening of the outer can 1 was fitted to the sealing body 2. Then the joint of the outer can 1 and the periphery of the sealing body 2 were laser welded. After injecting a predetermined amount of the above-mentioned non-aqueous electrolyte into a non-aqueous electrolyte injection hole (not shown) provided on the sealing body 2, this non-aqueous electrolyte injection hole was sealed to complete a non-aqueous electrolyte secondary cell according to Example 1. In this cell, the thickness ratio of negative electrode protective layer/separator is 13.3%. In addition, the porosity of the negative electrode active material layer was 49%, the porosity of the positive electrode active material layer was 33%, and the porosity of the negative electrode protective layer was 67%.

### Example 2

A non-aqueous electrolyte secondary cell according to Example 2 was fabricated in the same manner as above-described Example 1 except that the thickness of the negative electrode protective layer is 3.5 μm, and the separator made of polyethylene having the thickness of 26 μm was used. In this cell, the thickness ratio of negative electrode protective layer/separator is 26.9%.

### Comparative Example 1

A non-aqueous electrolyte secondary cell according to Comparative Example 1 was fabricated in the same manner as above-described Example 1 except that the negative electrode protective layer was not provided, and the separator made of polyethylene having the thickness of 30 μm was used.

### Comparative Example 2

A non-aqueous electrolyte secondary cell according to Comparative Example 2 was fabricated in the same manner as above-described Example 1 except that the thickness of the negative electrode protective layer was 6.5 μm, and the separator made of polyethylene having the thickness of 30 μm was used. In this cell, the thickness ratio of negative electrode protective layer/separator is 43.3%.

### Comparative Example 3

A non-aqueous electrolyte secondary cell according to Comparative Example 3 was fabricated in the same manner as above-described Example 1 except that the thickness of the negative electrode protective layer was 12.5 μm, and the separator made of polyethylene having the thickness of 30 μm was used. In this cell, the thickness ratio of negative electrode protective layer/separator is 83.3%.

The width and length of the positive and negative electrode were the same in all of the above-described Examples and Comparative Examples.

### <Productivity Test>

The electrode assemblies having the same discharge capacity were prepared according to above Examples 1 and 2 and Comparative Examples 1 to 3. Then, each of these electrode assemblies was inserted into an outer can with 118.8 mm width, 11.5 mm thickness and 82.9 mm height (All of these are internal dimensions.). At this time, such an electrode assembly that could not be inserted into the outer can was determined as “having a problem with the electrode assembly insertion”. Meanwhile, to each of cells into which the electrode assemblies could be inserted, 58 g of the above electrolyte was injected under reduced pressure. At this time, such a cell whose time required for the electrolyte injection was 4 hours or more was determined as “having a problem with the electrolyte injection”. Such a cell that had “no problem with both the electrode assembly insertion and electrolyte injection” was determined as a “good”. As a result, the cells of Examples 1 and 2 were “good”, the cell of Comparative Example 1 had “a problem with the electrolyte injection”, and the cells of Comparative Examples 2 and 3 had “a problem with the electrode assembly insertion”.

### <Inner Short-circuit Resistance Test>

For the cells according to above Examples 1 and 2, whose results of the productivity test were “good”, a forced short-circuit test according to JIS C8714 was performed. The cells were measured until applied force reached 400N. As a result, it was confirmed that voltage drop and ignition was not caused in all of the cells according to above Examples 1 and 2.

These results are discussed as follows.

When increasing a thickness of the negative electrode protective layer with discharge capacity kept constant, the volume of the electrode assembly becomes large. For this reason, the problem with the electrode assembly insertion occurs in Comparative Examples 2 and 3 in which the thickness of the protective layer is more than 40% of that of the separator. Meanwhile, when the protective layer is not provided, the above problem is not caused. However, in this case, since there is not obtained the effects of increasing the permeability of the non-aqueous electrolyte, injection fault occurs (cf. Comparative Example 1). In Examples 1 and 2 in which the thickness of the protective layer is regulated to 10 to 40% of that of the separator, the problems with the electrode assembly insertion and electrolyte injection do not occur. Moreover, since the positive and negative electrodes are securely insulated by the separator and protective layer, the results of the short-circuit resistance test are also good in Examples 1 and 2.

### SUPPLEMENTARY REMARKS

The positive electrode active material include, for example, lithium-containing transition metal composite oxides such as lithium-containing nickel cobalt manganese complex oxide (LiNiₓCo_{y}Mn_{z}O₂, x+y+z=1, 0≦x≦1, 0≦y≦1, 0≦z≦1), lithium manganese oxide (LiMn₂O₄), olivine-type lithium iron phosphate (LiFePO₄), and compounds obtained by substituting a part of transition metals contained in the above oxides with other elements. These compounds can be used alone or in a mixture of two or more.

As the negative electrode active material, there can be used, for example, carbonaceous materials such as natural graphite, carbon black, coke, glassy carbon, carbon fiber and calcined materials thereof. Also, there can be used a mixture of the above carbonaceous materials with at least one selected from the group consisting of lithium, lithium alloy and metal oxides capable of intercalating and deintercalating lithium.

In addition, the non-aqueous solvent can be a mixture of a low viscosity solvent and a high dielectric solvent having a high solubility of lithium salt. Examples of the high dielectric solvent include ethylene carbonate, propylene carbonate, butylene carbonate, and γ-butyrolactone. Examples of the low viscosity solvent include diethyl carbonate, dimethyl carbonate, ethyl methyl carbonate, 1,2-dimethoxyethane, tetrahydrofuran, anisole, 1,4-dioxane, 4-methyl-2-pentanone, cyclohexanone, acetonitrile, propionitrile, dimethylformamide, sulfolane, methyl formate, ethyl formate, methyl acetate, ethyl acetate, propyl acetate, and ethyl propionate. In addition, the non-aqueous solvent may be a mixture of one or more high dielectric solvents and one or more low viscosity solvents as listed above.

In addition, the electrolyte salt (lithium compound) dissolved into the non-electrolyte solvent includes LiPF₆, LiN(C₂F₅SO₂)₂, LiN(CF₃SO₂)₂, LiClO₄ and LiBF₄, all of which can be used alone or in combination of two or more as a fundamental electrolyte salt. Moreover, it is preferable that lithium bis(oxalate)borate, lithium difluorophosphate or the like is further added to the above fundamental electrolyte salt in order to contain two or more kinds of lithium compounds in the non-aqueous solvent. The total concentration of lithium salt in the non-aqueous electrolyte is preferably 0.5 to 2 M(mol/l).

Known additives such as vinylene carbonate, cyclohexyl benzene and tert-amylbenzene can be also added to the non-aqueous electrolyte.

As the separator, there can be used a microporous film composed of olefin resins such as polyethylene, polypropylene and a mixture or laminate thereof. The thickness of the separator is preferably 10 to 40 μm.

Moreover, by using a method of forming the protective layer after the rolling of the electrode active material layer, it becomes easy to make the porosity of the protective layer more than that of the electrode active material layer.

As explained above, the present invention can provide a non-aqueous electrolyte secondary cell having high productivity and excellent safety. Thus, the industrial applicability is significant.

1. A non-aqueous electrolyte secondary cell comprising an electrode assembly and a non-aqueous electrolyte,
wherein:
the electrode assembly has a positive electrode plate, a negative electrode plate, and a separator separating the positive and negative electrode plates;
the positive electrode plate has a positive electrode core and a positive electrode active material layer formed on the positive electrode core;
the negative electrode plate has a negative electrode core and a negative electrode active material layer formed on the negative electrode core;
a protective layer containing insulative inorganic particles is provided on the positive electrode active material layer and/or the negative electrode active material layer;
the total thickness of the protective layers is 10 to 40% of the thickness of the separator;
the porosity of the protective layer is larger than the porisity of any of the positive electrode active material layer and the negative electrode active material layer; and
the non-aqueous electrolyte contains a non-aqueous solvent and two or more kinds of lithium compounds dissolved in the non-aqueous solvent.

2. The non-aqueous electrolyte secondary cell according to claim 1, wherein the concentration of the lithium compounds in the non-aqueous electrolyte is 0.5 M to 2.0 M.

3. The non-aqueous electrolyte secondary cell according to claim 1, wherein the non-aqueous electrolyte contains three or more kinds of lithium compounds dissolved in the non-aqueous solvent.

4. The non-aqueous electrolyte secondary cell according to claim 1, wherein the non-aqueous electrolyte contains lithium bis(oxalate)borate as the lithium compound.

5. The non-aqueous electrolyte secondary cell according to claim 1, wherein the non-aqueous electrolyte contains lithium difluorophosphate as the lithium compound.

6. The non-aqueous electrolyte secondary cell according to claim 3, wherein the non-aqueous electrolyte contains lithium bis(oxalate)borate and lithium difluorophosphate as the lithium compounds.

7. The non-aqueous electrolyte secondary cell according to claim 1, wherein the non-aqueous electrolyte secondary cell has a discharge capacity of 4 Ah or more.

8. The non-aqueous electrolyte secondary cell according to claim 1, wherein:
the negative electrode has a negative electrode core exposed portion in which the negative electrode active material layer is not formed and the negative electrode core is exposed; and
the protective layer is formed on the negative electrode active material layer and on the negative electrode core exposed portion that is continuous to the negative electrode active material layer.

9. The non-aqueous electrolyte secondary cell according to claim 1, wherein:
the positive electrode has a positive electrode core exposed portion in which the positive electrode active material layer is not formed and the positive electrode core is exposed; and
the protective layer is formed on the positive electrode active material layer and on the positive electrode core exposed portion that is continuous to the positive electrode active material layer.

10. The non-aqueous electrolyte secondary cell according to claim 1, wherein the porosity of the protective layer is 60 to 90%.

11. The non-aqueous electrolyte secondary cell according to claim 1, wherein the thickness of the protective layer is 1 to 10 μm.

12. The non-aqueous electrolyte secondary cell according to claim 1, wherein the average particle diameter of the insulative inorganic particles is 0.1 to 10 μm.

13. The non-aqueous electrolyte secondary cell according to claim 1, wherein the insulative inorganic particles are at least one kind of particles selected from the group consisting of alumina particles, titania particles and zirconia particles.

14. A non-aqueous electrolyte secondary cell comprising an electrode assembly and a non-aqueous electrolyte,
wherein:
the electrode assembly has a positive electrode plate, a negative electrode plate, and a separator separating the positive and negative electrode plates;
the positive electrode plate has a positive electrode core and a positive electrode active material layer formed on the positive electrode core;
the negative electrode plate has a negative electrode core and a negative electrode active material layer formed on the negative electrode core;
a protective layer containing insulative inorganic particles is provided on the positive electrode active material layer and/or the negative electrode active material layer in a continuous layer;
the total thickness of the protective layers is 10 to 40% of the thickness of the separator;
the porosity of the protective layer is larger than the porisity of any of the positive electrode active material layer and the negative electrode active material layer; and
the non-aqueous electrolyte contains a non-aqueous solvent and two or more kinds of lithium compounds dissolved in the non-aqueous solvent.

15. The non-aqueous electrolyte secondary cell according to claim 14, wherein:
the negative electrode has a negative electrode core exposed portion in which the negative electrode active material layer is not formed and the negative electrode core is exposed; and
the protective layer is formed on the negative electrode active material layer and on the negative electrode core exposed portion that is continuous to the negative electrode active material layer.

16. The non-aqueous electrolyte secondary cell according to claim 14, wherein:
the positive electrode has a positive electrode core exposed portion in which the positive electrode active material layer is not formed and the positive electrode core is exposed; and
the protective layer is formed on the positive electrode active material layer and on the positive electrode core exposed portion that is continuous to the positive electrode active material layer.

17. A non-aqueous electrolyte secondary cell comprising an electrode assembly and a non-aqueous electrolyte,
wherein:
the electrode assembly has a positive electrode plate, a negative electrode plate, and a separator separating the positive and negative electrode plates;
the positive electrode plate has a positive electrode core and a positive electrode active material layer formed on the positive electrode core, the positive electrode active material layer comprising a positive electrode active material and a positive electrode binder;
the negative electrode plate has a negative electrode core and a negative electrode active material layer formed on the negative electrode core, the negative electrode active material layer comprising a negative electrode active material and a negative electrode binder;
a protective layer containing insulative inorganic particles is provided on the positive electrode active material layer and/or the negative electrode active material layer, the protective layer being in contact with positive electrode binder at an interface between the protective layer and the positive electrode active material layer and/or the protective layer being in contact with negative electrode binder at an interface between the protective layer and the negative electrode active material layer;
the total thickness of the protective layers is 10 to 40% of the thickness of the separator;
the porosity of the protective layer is larger than the porisity of any of the positive electrode active material layer and the negative electrode active material layer; and
the non-aqueous electrolyte contains a non-aqueous solvent and two or more kinds of lithium compounds dissolved in the non-aqueous solvent.

18. The non-aqueous electrolyte secondary cell according to claim 17, wherein:
the negative electrode has a negative electrode core exposed portion in which the negative electrode active material layer is not formed and the negative electrode core is exposed; and
the protective layer is formed on the negative electrode active material layer and on the negative electrode core exposed portion that is continuous to the negative electrode active material layer.

19. The non-aqueous electrolyte secondary cell according to claim 17, wherein:
the positive electrode has a positive electrode core exposed portion in which the positive electrode active material layer is not formed and the positive electrode core is exposed; and
the protective layer is formed on the positive electrode active material layer and on the positive electrode core exposed portion that is continuous to the positive electrode active material layer.
